(19) United States
(12) Patent Application Publication
(10) Pub. No.: US 2001/0055037 A1
(43) Pub. Date: Dec. 27, 2001

(54) Communications system, article of manufacture and method related to modifying operation of a communications system

(76) Inventors: Michael J. Pallett, Orangeville (CA); Alexandru Moraru, Toronto (CA); Paul V. Vrana, Mississauga (CA)

Correspondence Address: R. Kent Roberts, Hodgson Russ LLP, Suite 2000, One M&T Plaza, Buffalo, NY, 14203-2391, US

(21) Appl. No.: 09/882,658

(22) Filed: Jun. 15, 2001

Related U.S. Application Data
(60) Provisional application No. 60/211,924, filed on Jun. 16, 2000.

(51) Int. Cl. G09G 5/00

(52) U.S. Cl. 345/763

(57) ABSTRACT

The invention includes a method, an article of manufacture and a system related to controlling a communications system. A trigger signal and an action signal are associated, and when the trigger signal is provided, the action signal is provided.

### CROSS CLAIM TO RELATED APPLICATION

This application claims priority to U.S. provisional Pat. application Ser. No. 60/211,924, filed Jun. 16, 2000.

### BACKGROUND INFORMATION

The invention relates generally to devices and methods of controlling a communications system. Existing communications systems, such as intercom, paging, telephone, conferencing, media retrieval, and time and event tracking systems have disadvantages. For example, existing systems require expensive and time consuming revisions if it is desired to change certain features available to end users. A new or different feature to be provided by the system may usually be provided only if the software, firmware or hardware is updated. Such updates normally require manufacturers to define and develop the software code, firmware, or hardware, conduct testing, prepare documentation, and then supply the updated code, firmware or hardware to the end user. This is a time consuming and expensive process. It is also difficult to predict with certainty the time and effort required to make such updates when beginning development of each new feature.

Furthermore, existing communications systems can not be easily integrated with other systems, both communications systems and non-communications systems. If integration with a communications system and some other system is achievable, similar expensive and time consuming revisions to the communications system must be made.

### BRIEF DESCRIPTION OF THE DRAWINGS

For a fuller understanding of the nature and objects of the invention, reference should be made to the following detailed description taken in conjunction with the accompanying drawings, in which:

FIG. 1 is a block diagram of a system according to the invention;

FIG. 2 is a block flow diagram of a method according to the invention; and

FIGS. 3 is a block flow diagram of a method according to the invention.

### DETAILED DESCRIPTION

Briefly, one embodiment of the invention selectively associates a trigger signal with one or more action signals so that if the trigger signal is provided, the associated action signals are provided. The invention may be used in many types of communications systems, such as paging systems, telephone systems, conferencing systems, media retrieval systems, and time and event tracking systems. For example, in an intercom system a trigger signal may be provided by a user communication device in response to a person pressing a button on an intercom station. An action signal associated with such a trigger signal may cause illumination of a light on a system operator's console or may cause production of a tone to alert the system operator.

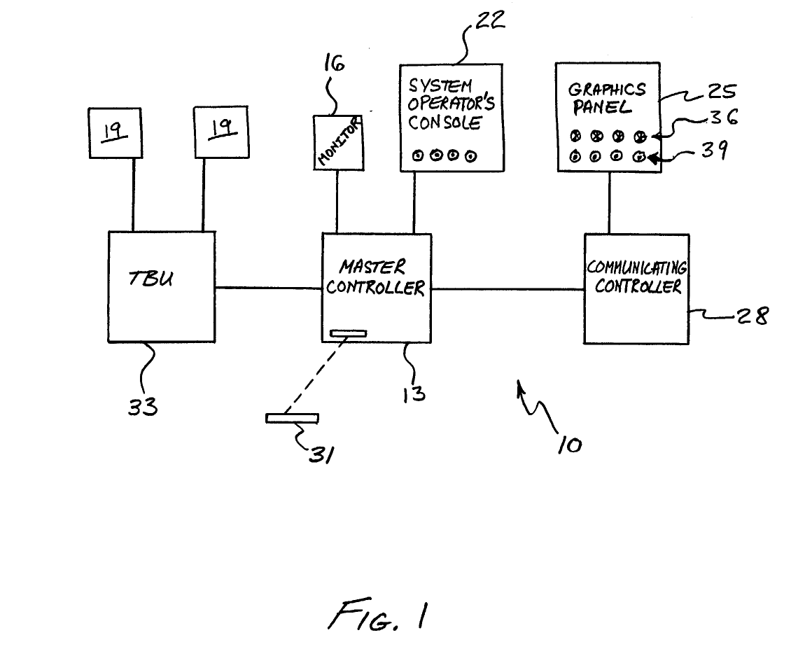

FIG. 1 will be used to provide an overview of one system according to the invention. A communications system 10 according to the invention may have a master controller 13. The master controller 13 may be connected to a monitor 16, and a list of action signal icons and a list of trigger signal icons may be displayed on the monitor 16. Each action signal icon may correspond to a signal that affects a change (herein referred to as an “action signal”) in the communications system 10 or in devices not associated with the communications system 10. An action signal may be sent by a device in the communications system 10, such as the master controller 13 or the communicating controller 28. Each trigger signal icon may correspond to a signal (herein referred to as a “trigger signal”) that may be provided to report a change in the communications system 10. A trigger signal may be provided by a device in the communications system 10, such as an intercom device 19, graphics panel 25 or communicating controller 28, or may be provided by a device primarily associated with some other system.

A person may modify an association between an action signal icon and a trigger signal icon by using a mouse or key board connected to the master controller 13. For example, an existing association between a trigger signal icon and an action signal icon may be modified by clicking on the trigger signal icon to highlight the trigger signal icon displayed on the monitor 16, then dragging the corresponding action signal icon away from the highlighted trigger signal icon, and then clicking and dragging the desired action signal icon to the highlighted trigger signal icon. Another way to modify an existing association between a trigger signal icon and an action signal icon may be by displaying the trigger signal icons and displaying the action signal icons, clicking on the trigger signal icon and clicking on the action signal icon that will be associated, and then clicking on a button to cause the master controller 13 to carry out the association between the signal corresponding to the trigger signal icon and the signal corresponding to the action signal icon.

The invention may be implemented via a graphical user interface using C++ and the Object Windows Library™ corresponding to Windows 95™, Windows 98™, Windows NT 4.0™ or Windows 2000™, but other computer programming languages and operating systems can be used to implement the invention. Many different hardware platforms may be used to accommodate the unique needs of different communications systems. For example, different hardware platforms may be implemented for intercom systems, paging systems, telephone systems, conferencing systems, media retrieval systems, and time and event tracking systems. Nevertheless, different hardware platforms may have many similarities.

As an example, the communications system may be an intercom system. As used herein, the term “user communication device” includes any device that may be used by a person, such as a system operator or intercom station user to report a change in the communications system. A user communication device may be an intercom station 19, as shown in FIG. 1, that has a call button, or the user communication device may be buttons on a system operator's console 22, or buttons on a graphics panel 25. Although the invention is described herein with regard to a graphics panel 25, it will be recognized that other devices may be substituted for the graphics panel 25, such as a monitor with a touch sensitive screen or a keyboard. The term “user communication device” is also used herein to refer to a device, for example a TBU (termination unit) or PLC (programmable logic controller), that accepts a first trigger signal from another user communication device, and provides a second trigger signal in response to receipt of the first trigger signal. Such trigger signals do not change the communications system, but ultimately result in a change being affected by an action signal.

When an individual (the “caller”) desires to speak with a system operator, the caller presses the call button on the intercom station 19. In response to pressing the call button, a trigger signal may be sent from the intercom station 19 to the master controller 13. The master controller 13 then receives the trigger signal from the intercom station 19 and identifies an associated action signal. The master controller 13 then provides the action signal to affect a change in the communications system 10. For example, the action signal may be provided to a communicating controller 28, which may be a PLC or a personal computer, and in response, the communicating controller 28 takes the desired action to change the communications system 10. A change in the communications system 10 may be, for example, causing a light 36 to flash on the graphics panel 25. Upon seeing the flashing light 36, the system operator presses a button 39 on the graphics panel 25 corresponding to the flashing light. By pressing the button 39 on the graphics panel 25, a signal is sent to the communicating controller 28, which in turn provides a trigger signal to the master controller 13. In response to receiving the trigger signal, the master controller 13 identifies an associated action signal, and provides the action signal.

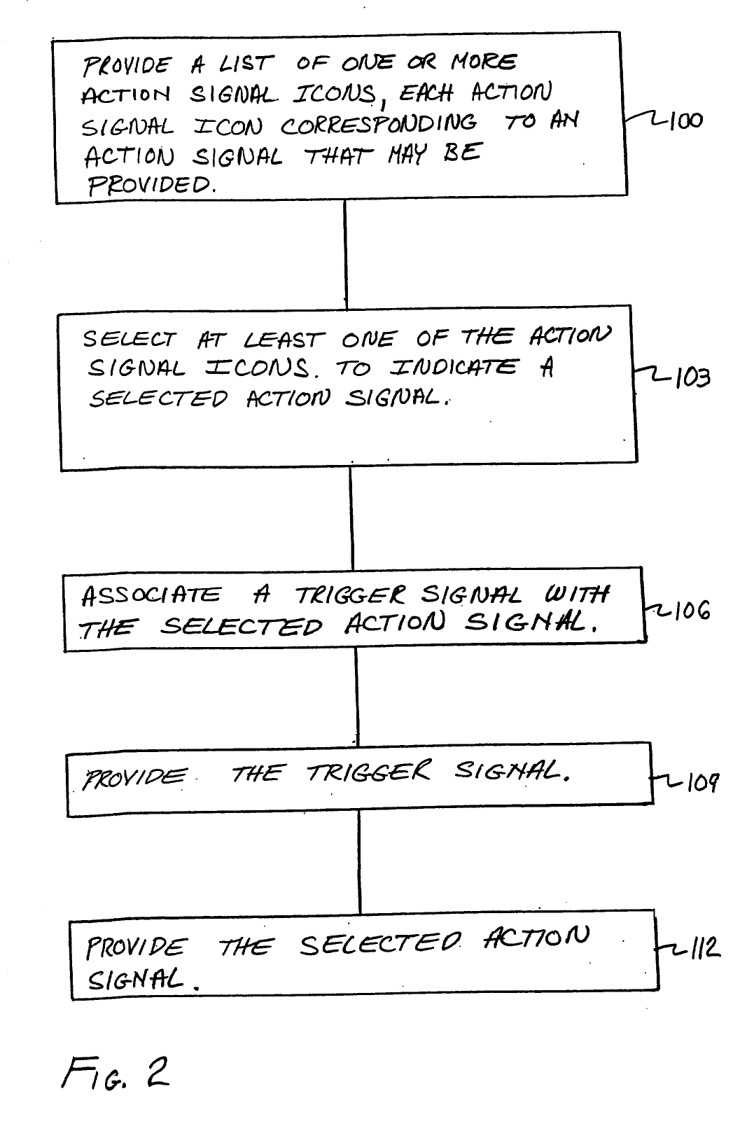

Now that a brief overview of an embodiment of the invention has been given, additional details of the invention will be given. FIG. 2 illustrates a method according to the invention. In the method of FIG. 2, a communications system is controlled. The communications system may have a user communication device capable of providing a trigger signal, or the user communication device may be connected to a communicating controller, such as a PLC, that is capable of providing the trigger signal to the master controller.

A list of one or more action signal icons may be provided 100, for example by the master controller, to a system organizer. Each action signal icon may correspond to an action signal that may be provided. At least one of the action signal icons may be selected 103 to indicate a selected action signal. In response to selecting one of the action signal icons, the trigger signal may be associated 106 with the selected action signal. Then, when the trigger signal is provided 109, the associated action signal may be provided 112. As implied above, more than one action signal may be associated with the trigger signal.

The list of one or more action signal icons may be provided 100 via a monitor connected to the master controller. A graphical user interface may be used by the master controller to provide the list of one or more action signal icons to the monitor. Selecting 103 at least one of the action signal icons may be accomplished by moving an identifying icon displayed on the monitor until the identifying icon coincides with one of the action signal icons. For example, a mouse may be used to control the position of the identifying icon on the monitor, and when the identifying icon coincides with a desired action signal icon, the mouse is clicked. Associating 106 the trigger signal with the selected action signal may include instructing the master controller or the communicating controller to provide 112 the selected action signal if the trigger signal is provided 109.

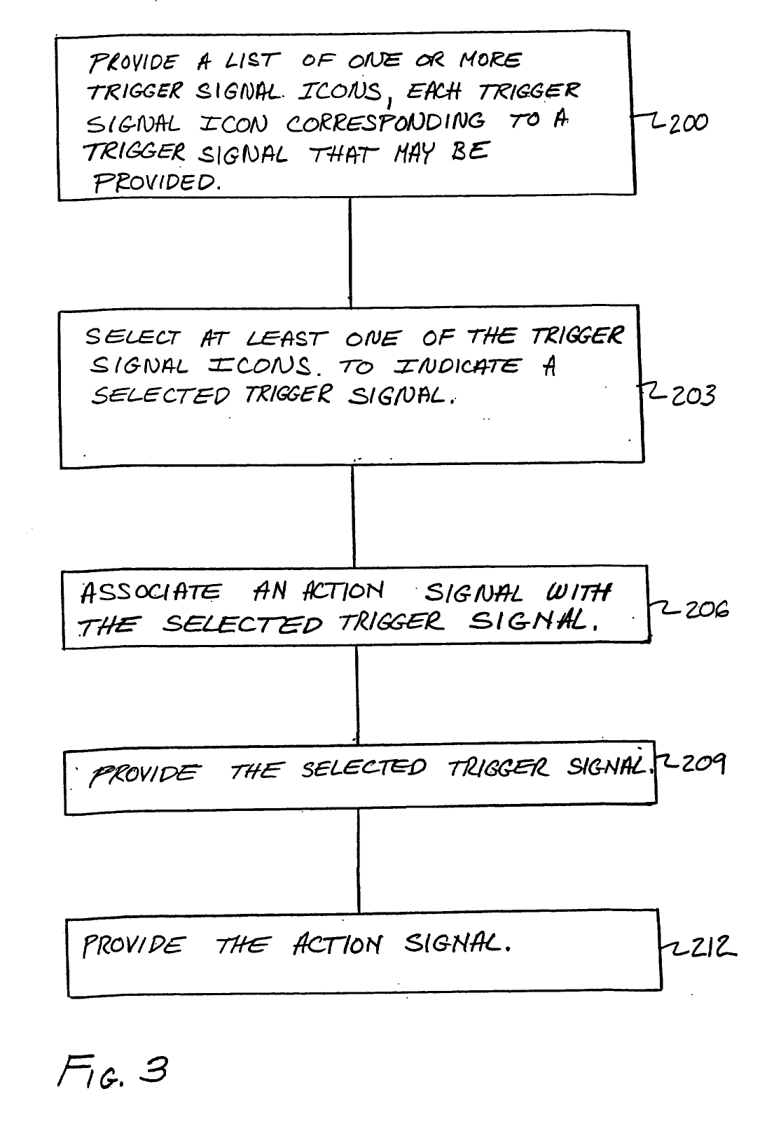

FIG. 3 shows another method according to the invention. For reasons of brevity, the communications system described above with reference to FIG. 2 will be assumed in describing the method of FIG. 3. A list of one or more trigger signal icons may be provided 200, each trigger signal icon corresponding to a trigger signal that may be provided. Then, at least one of the trigger signal icons may be selected 203 to indicate a selected trigger signal. Then, the action signal may be associated 206 with the selected trigger signal. Then, when the trigger signal is provided 209, the associated action signal may be provided 212. As implied above, more than one trigger signal may be associated with the action signal.

The list of one or more trigger signal icons may be provided 200 via a monitor. A graphical user interface may be used by a computer to provide the list of one or more trigger signal icons to the monitor. To select 203 at least one of the trigger signal icons, an identifying icon displayed on the monitor may be moved until the identifying icon coincides with one of the trigger signal icons. For example, a mouse may be used to control the position of the identifying icon on the monitor, and when the identifying icon coincides with a desired trigger signal icon, the mouse is clicked. Associating 206 the action signal with the selected trigger signal may include instructing the controller to provide 212 the selected action signal if the trigger signal is provided 209.

In one embodiment of the invention, an augmented trigger signal is formatted to include at least one trigger signal and at least one device portion. The trigger signal may correspond to a function expected by a user, for example, ending a call. The device portion may correspond to a device to which the expected function should be applied, for example, the intercom station of room #2. When such an augmented trigger signal is received, a method according to the present invention identifies the trigger signal of the augmented trigger signal, and identifies the device portion of the augmented trigger signal. The trigger signal is used to select the associated action signal. The device portion may be added to the selected action signal to form an augmented action signal.

For example, upon receiving one type of augmented trigger signal, a place/end string may be identified as a trigger signal. Upon identifying the place/end string, a determination may be made as to whether a line of communication is open. If a place/end string is identified and it is determined a line of communication is open, then the line of communication is closed. If the place/end string is identified and the augmented trigger signal includes a device portion corresponding to a device for which a line of communication is not open, then a line of communication may be opened to the device corresponding to the device portion.

The invention includes an article of manufacture 31 that has a computer usable medium having computer readable program code instructions embodied therein. The computer usable medium may be, for example, a compact disc, random access memory or read only memory. The instructions may cause a computer, such as a computer associated with the master controller referenced above, to associate a trigger signal with an action signal via one or more computer readable program code modules. One such module may provide a list of one or more action signal icons, each action signal icon corresponding to an action signal that may be provided. Another module may provide a list of one or more trigger signal icons, each trigger signal icon corresponding to a trigger signal that may be provided. The instructions may also include a module to receive a selection of one of the action signal icons, and a module to receive a selection of one of the trigger signal icons. Furthermore, the instructions may include a module to associate the action signal corresponding to the selected action signal icon with a trigger signal corresponding to the selected trigger signal icon. As an example, the lists of icons may include icons corresponding to action signals and trigger signals for an intercom system.

The code modules to provide the lists of action signal icons and trigger signal icons may be capable of providing the lists to a monitor, and the monitor may display these lists to a system organizer. For example, these code modules may include or use a graphical user interface, and such a graphical user interface may be capable of allowing a system organizer to move an identifying icon displayed on the monitor to make the identifying icon coincide with one of the action signal icons or one of the trigger signal icons. The code module to associate the action signal with the trigger signal may include instructions capable of causing a signal provider, such as a master controller, to provide an action signal corresponding to the selected action signal icon if the associated trigger signal is provided.

One article of manufacture 31 according to the invention includes a computer readable program code module to identify a device portion of an augmented trigger signal, and to format an augmented action signal to include an action signal associated with the trigger signal and the device portion. In this manner, the provided action signal may be directed so as to have an effect on a device that corresponds to the device portion.

The article of manufacture 31 may also include a computer readable program code module for sending secondary action signals to devices associated with the device identified in the device portion. For example, if communications are to be established between a system operator and an intercom station 19, secondary action signals may include turning on a light in a hallway where the intercom station 19 is located. The secondary action signals are in addition to those action signals required to establish communications between the system operator and the intercom station 19.

An example of an article of manufacture 31 according to the invention includes a code module to determine whether a received trigger signal is a place/end string, and in response to determining that the place/end string was received, to determine whether a line of communication is open. A code module may include instructions for closing a line of communication if it was determined a line of communication was open and if it was determined the place/end string was received. This code module, or another code module, may further include instructions to open a line of communication to a device corresponding to a device portion associated with the received trigger signal if the received trigger signal includes the place/end string.

The invention includes a communications system 10 having a user communication device in communication with a master controller 13. The system 10 may also have a communicating controller 28 in communication with the master controller 13. The master controller 13 may be a computer having software running thereon that is capable of associating a trigger signal from the user communication device with an action signal that will be provided if the trigger signal is provided. The software running on the master controller may use a graphical user interface to facilitate associating the trigger signal with an action signal to be provided if the trigger signal is provided. The invention may include a monitor 16 in communication with the master controller 13. The monitor 16 may be capable of displaying a trigger signal icon corresponding to the trigger signal, and may be capable of displaying an action signal icon corresponding to the action signal. When displayed, a system organizer may select a trigger signal and an action signal, and the master controller 13 may be instructed to associate the trigger signal with the action signal.

In one embodiment of a communications system 10 according to the present invention, an augmented trigger signal is formatted to include a trigger signal and a device portion. The trigger signal corresponds to a function that is expected by a user, for example, ending a call. The device portion corresponds to a device to which the expected function should be applied, for example, the intercom station of room #2. When an augmented trigger signal is received, the master controller 13 identifies from the augmented trigger signal the trigger signal and the device portion. The trigger signal is used by the master controller 13 to select the associated action signal. The device portion may be added to the selected action signal to form an augmented action signal so that the action signal causes an effect related to the device that corresponds to the device portion.

In one embodiment of a system 10 according to the invention, the master controller 13 determines whether the received trigger signal is a place/end string. The master controller 13 also determines whether a line of communication is open. If the received trigger signal is a place/end string and a line of communication is open, then the master controller 13 provides an action signal that results in closing the line of communication. If an augmented trigger signal is received wherein the trigger signal is determined to be a place/end string, and the received augmented trigger signal also includes a device portion corresponding to a device for which a line of communication is not opened, then an action signal is provided by the master controller 13 that results in a line of communication being opened to the device corresponding to the device portion.

The invention will now be further described by way of an example. In this example, an intercom system 10 has a master controller 13, referred to in this example as the “T3-SC”, in communication with a communicating controller 28, which is a PLC. The T3-SC is a microprocessor-based communications control unit that has a resident processor, memory, controller and audio circuitry to provide a complete communications platform. The T3-SC may integrate with other new or existing systems in a facility. By using the T3-SC, a facility's central control point, such as a computer touch screen or graphics panel 25, can be used to support intercom system functions. As will be illustrated, all that is necessary to integrate the T3-SC into a communications system are four serial messages transmitted between the T3-SC and the PLC. The T3-SC has all the intelligence necessary to support integration, which relieves the PLC of all intercom responsibility other than the user interface (i.e. computer touch screen or graphics panel). Using the T3-SC, the PLC is not required to handle or keep track of any intercom functions, such as annunciating call-ins, sounding tones, managing communications hardware, or tracking call status. As such, the code required for operation of the PLC may be greatly simplified.

The T3-SC uses intercom functions, such as answering a call-in, as a basis for integration from which the PLC is able to react. These intercom functions are capable of triggering, or providing, serial messages to the PLC to cause specific activity. For example, when a system operator places a call to an intercom station, the T3-SC may provide a serial message to the PLC to tell it to light the intercom station's LED on the graphics panel 25. Any activity via a system operator's console or via an intercom station may trigger a serial message, but only a few serial messages are necessary for complete integration.

The T3-SC is capable of receiving serial messages from the PLC to execute intercom functions. With the T3-SC, intercom functions are represented as system commands. In addition to system commands that allow for remote operation, an advanced system command that has all the integral programming necessary for T3-SC/PLC functionality can be used. A single system command and three simple serial messages sent to the PLC are all that are necessary to realize an integrated communication platform.

To minimize PLC programming, interaction between the PLC and T3-SC is based on a “one-to-one” relationship between the action of the users and the response of the PLC. In such a T3-SC based intercom system, the PLC responds with a single action for each event. For example, in response to a user pressing a direct-select button, the PLC is required to provide only a single message, the same message, regardless of the circumstances. In doing so, the PLC does not need to manage the circumstances surrounding a user's actions.

FIG. 1 illustrates a communications system wherein a graphics panel 25 serves as a control point. The graphics panel 25 is connected to the PLC (communicating controller 28), and the T3-SC is connected to the PLC via, for example, an RS232 cable. Connected to the T3-SC may be a T3-TBU-25-I/O 33. Other types of TBU's may be connected to the T3-SC. In this example, a T3-SC accepts a maximum of thirty-one TBUs 33. In this example, each TBU 33 has relay switching facilities and the call-in decoding for twenty-five intercom stations. Such a system 10 may further include a system operator's console 22, which provides the circuitry to control speaker, microphone, PTT (push to talk) and cancel buttons of a master intercom station. On the graphics panel 25, each intercom station 19 has an associated light emitting diode (“LED”) 36 and an associated direct-select button 39 near the LED 36. This exemplary system will now be described in operation to illustrate how an intercom system according to the present invention might answer a call-in from an intercom station 19.

When an intercom station 19 makes a call-in to its assigned console 22, the T3-SC is responsible for instructing the PLC to alert the system operator. When a call button on an intercom station 19 is pressed to alert the system operator, the T3-SC recognizes the call-in and provides it to the assigned console 22. The console 22 receives the call-in, and announces it with a tone. A call-in may be considered a type of trigger signal that may result in providing an action signal that results in sounding the tone, as described above. In addition, in response to receiving the call-in, another action signal may be provided to the PLC which causes the PLC to flash one of the LED's 36 on the graphics panel 25.

In this example, an action signal sent to the PLC will be referred to from time to time as a “serial port message action signal”. A serial port message action signal may be in a particular format, for example, a simple string. The PLC may expect to receive a certain message action signal whenever the system operator needs to be alerted of a call-in from room #3, for example, the message action signal “F3”. To create the message action signal “F3”, the string may merely have the “F” character followed by a variable that in this case takes on the value of “3”. In response to receiving the F3 message action signal, the PLC may be responsible for flashing LED #3 on the graphics panel 25 whenever the PLC receives this serial port message action signal.

To identify a serial port message action signal to the system operator, an icon corresponding to the serial port message action signal may be provided. For example, if the message action signal causes an LED 36 to flash, the icon corresponding to the serial port message action signal that is sent to the PLC to cause the PLC to flash the LED 36 might be Flash LED. This icon may be used to program the T3-SC so that the serial port message action signal corresponding to Flash LED is associated with a call-in trigger signal.

Trigger signal icons and action signal icons may be presented to a system organizer in order to facilitate association of a trigger signal and a serial port message action signal. In the example above, the Flash LED icon may be associated with the icon Received Intercom Call-in. As a result of such an association, whenever the T3-SC receives a call-in trigger signal, the T3-SC provides the message action signal corresponding to the Flash LED icon to the PLC.

When the PLC receives the Flash LED message action signal, the PLC is expected to flash the LED 36, which alerts the system operator. Flashing the LED 36 may be the only responsibility of the PLC when it receives this message action signal. The T3-SC's responsibility, when a user places a call-in, may be to handle all the other aspects of the call-in, including instructing the PLC.

When the system operator answers a call-in by pressing a direct-select button 39 on the graphics panel 25 that is associated with the flashing LED 36, the PLC may be responsible for informing the T3-SC, in order that the T3-SC may establish audio communications with the intercom station. When the system operator presses the direct-select button 39 to answer the call-in, the PLC's only responsibility may be to inform the T3-SC that the direct-select button 36 was pressed. The T3-SC may be informed by a serial message augmented trigger signal that includes a trigger signal and a device portion, such as the room number associated with the pressed direct-select button. For example, the serial message augmented trigger signal might be “PRESS12”, “P12” or “DSB12” when the direct-select button 39 for room #12 is pressed.

Serial message trigger signals may be distinguished by the T3-SC and associated with intercom functions. This association may be created in T3-SC programming as an inbound command. To program an inbound command, the system organizer might create a simple string (referred to herein as an “inbound command string”) that represents the serial message trigger signal, and select the desired intercom function from a list of intercom functions for the intercom system. For example, to represent the “DSB12” serial message trigger signal, the inbound command string might be “DSB$DestStation”. The “$DestStation” part of the inbound command string is the device portion. In this example, when the T3-SC receives the serial message “DSB12”, the T3-SC recognizes the “12” as a device portion of the inbound command string and then assigns the value of “12” to “$DestStation”. Having assigned the number 12 to the string “$DestStation”, an associated action signal having the string “$DestStation” would include the number 12.

As part of establishing audio communication, the T3-SC may register the call-in as being answered. To accomplish this, the T3-SC may have a command that automatically completes both tasks, referred to herein as the “place or end command”. The place or end command is an example of a system command. Many system commands may be made available to execute a variety of intercom functions within the T3-SC. For example, the place or end command may be the only command required for the system operator to answer a call-in.

A serial message action signal may be automatically provided whenever an inbound command string is identified in a serial message trigger signal. The T3-SC may look for a match between an inbound command string and a list of possible serial message action signals. When a match is identified, the corresponding serial message action signal may be provided. For example, the place or end command may be provided when the T3-SC receives the serial message “DSB12”. Providing the serial message trigger signal for the place or end command may be the only responsibility of the PLC when the system operator presses the direct-select button 39 to answer a call-in. Managing all other aspects of answering the call-in may be the responsibility of the T3-SC.

When an intercom station 19 call-in is answered, the T3-SC may be responsible for instructing the PLC to notify the system operator that an audio path has been established. When the call-in is answered, the system operator expects the LED 36 for that room to be continuously lit, indicating an open audio path. To continuously light the LED 36, the T3-SC may provide the PLC an action signal in the form of a serial message whose icon is referred to herein as Light LED. For the PLC to light LED #5, the serial message may be “L5”. The format of the serial port message action signal corresponding to the icon Light LED may be defined as “L$Station”. The “L” character tells the PLC to light a LED. The “$Station” variable is assigned the value of “5” when the call-in of room #5 is answered, the Light LED action signal is then formatted as “L5” and is sent to the PLC. In this example, when the PLC receives “L5”, it will light the LED 36 corresponding to room #5 on the graphics panel 25. Lighting the LED 36 may be the only responsibility of the PLC when it receives this message.

To end a call with a room, the system operator may press the direct-select button 39 again. Pressing the direct-select button 39 again will cause the place or end command to be provided; the same system command that started the call. Although the place or end command started the call, it may also be used to end the call if the T3-SC is designed to automatically support all the different ways a direct-select button could be used. In this example, each time a direct-select button 39 is pressed, the place or end command may be provided as a trigger signal, and depending on the current state of the T3-SC, the required functions may be executed. This dramatically reduces the complexity of the code for the PLC.

In this example, when a direct-select button 39 on the graphics panel 25 is pressed by the system operator to end the call, the PLC may inform the T3-SC by a serial message trigger signal. This serial message trigger signal may be the same each time a direct-select button 39 is pressed. For example, when direct-select button #12 is pressed again to end the call, the PLC may provide again the serial message “DSB12”. The T3-SC receives the serial message “DSB12” and may match it to the “DSB$DestStation” inbound command string. The T3-SC then recognizes that “12” in the inbound command string corresponds with “$DestStation”. The T3-SC also recognizes the inbound command string includes “DSB” and the place/end string, and proceeds to determine the current state, which is that a call is in progress. The T3-SC then determines the associated action signals, and provides the associated action signals needed to disconnect audio communication with room #12 and register the call as being ended. As will now be recognized, the place or end command may be used to affect more than one change in the communications system, which eliminates time-consuming and complex programming of the PLC.

When the T3-SC is used to end a call to an intercom station 19, the T3-SC is responsible for instructing the PLC to notify the system operator that the call has been ended. When the call is ended, the system operator expects the lighted LED 36 to turn off, indicating the audio path is disconnected. In this example, to turn off a LED 36, the PLC must receive the action signal corresponding to the turn off LED icon, which may be a serial message provided by the T3-SC. For the PLC to turn off LED #12, for example, the action signal may be in the form of “012”. Assuming the trigger signal to end a call has been associated with the action signal to turn off an LED 36, when the end call serial message trigger signal “DSB12” is received, the “012” serial message action signal is sent to the PLC. When the PLC receives “012”, the PLC turns off the LED 36. Turning off the LED 36 may be the only responsibility of the PLC when it receives this message.

It will now be recognized that by associating a trigger signal with an action signal, the T3-SC may provide messages to cause actions. By using the place or end command in a trigger signal, a number of action signals may result from one trigger signal. As will now be recognized, a system operator can first place a call, and then end the call while simultaneously answering a call-in. As an example, the operator may place a call to room #8 by pressing the direct-select button #8 on the graphics panel. This activates the place or end command, which establishes audio communication with room #8 and registers the call as being placed. In this example, an icon associated with a trigger signal corresponding to placing a call may be Light LED. The corresponding trigger signal may be “L$Station”. When the T3-SC is used to place a call to room #8, the PLC lights LED #8. The PLC does not need to keep track of calls or call-ins in the system. It only needs to light the LEDs 36 on the T3-SC's cue. If a call is in progress with room #8 and a call-in is made from room #20, the T3-SC receives the call-in, and provides the action signal corresponding to the icon Flash LED, which may be “F20”, to the PLC.

With LED #20 flashing, the system operator could first end the call with room #8, but the natural tendency of the system operator may be to press direct-select button #20 to answer the call-in. With the T3-SC, either option is possible. For this example, the system operator follows his natural tendency and presses direct-select button #20, which causes the PLC to provide the serial message trigger signal “DSB20” to the T3-SC. When the T3-SC receives “DSB20”, it recognizes the serial string “DSB” as the place or end command as a trigger signal. The place or end command causes the call with room #8 to be ended. When the call to room #8 is ended, the T3-SC causes the Turn Off LED action signal to be sent, which may be “08”, to the PLC. The PLC receives “08” and turns off LED #8, indicating that audio communication is disconnected. In addition, the place or end command causes the call-in of room #20 to be answered. When the call-in is answered, the T3-SC provides the Light LED action signal, which may be “L20”, to the PLC. The PLC receives “L20” and lights LED #20, indicating that audio communication is established.

In these examples, the place or end command is able to execute many of the intercom functions the system operator requires. In turn, these functions are able to notify the system operator of what is occurring, resulting in a fully-functional interface.

As will now be appreciated, the T3-SC has all the intelligence necessary to support an effective user interface. The PLC is not required to manage any intercom functions. The only function of the PLC is to act—not think. The T3-SC does all the thinking by associating trigger signals with action signals in the context of a fully operation intercom system, for example by using the place or end command whenever a direct-select button is pressed. Since action signals and trigger signals can be associated and disassociated, at the will of the system organizer, changes in how the communications system functions may be made without providing new software or firmware. Furthermore, changes in the systems interfacing with a communications system may be made by associating the new system's trigger signals with the action signals of the communications system.

It will be recognized that a user communication device may provide a trigger signal in one format, and then that trigger signal may be translated into a trigger signal that the master controller can recognize. For example, upon pressing a DSB button 39 on the graphics panel, a type of trigger signal is sent to the communicating controller 28, which then translates that trigger signal into a trigger signal that the master controller recognizes. Similarly, upon pressing a button on an intercom station 19, a type of trigger signal may be sent to the TBU. The TBU may translate the trigger signal from the intercom station 19 into a trigger signal that the master controller recognizes.

Integration is not just limited to a user interface. Other systems, such as closed circuit television or water control, may be operated in conjunction with intercom system functioning. To illustrate how the T3-SC might integrate with other systems, consider a call-in that is initiated from a shower. The T3-SC can be programmed to associate a trigger signal for answering a call from a shower room with an action signal to turn off water to the shower. For example, in response to the system operator pressing the direct select button 39 for the shower room, not only is the place or end command sent to establish audio communication, but a serial port message action signal may be sent to cause a solenoid to operate a water valve in order to turn off the water to the shower so the sound of the shower does not interfere with the audio between the users. By integrating with other systems, a complete communications and security platform may be controlled from a central control location.

It may be appreciated that using the invention, it is possible to allow a system organizer to create features and customize operation of a communications system without resorting to changing the firmware, software or hardware, and without involving the manufacturer. The invention does not require a system organizer to write or modify any computer code, but allows the system organizer to expand and customize the functional capabilities of a communications system. Such expansion and customization can allow the communications system to interface with other communications systems, or with systems in which communications is not the primary goal (“non-communications systems”), but in which the state of a non-communications system may impact a communications system, or in which a non-communications system may be impacted by a communications system. One way of doing so, would be to provide the non-communications system with the ability to provide trigger signals to the communications system 10, and/or provide the non-communications system with the ability to react to action signals. As such, the phrase “user communication device” as used herein to include any device capable of providing a trigger signal, whether that device is in a communications system or a non-communications system.

Although the invention has been described with respect to one or more particular embodiments, it will be understood that other embodiments of the invention may be made without departing from the spirit and scope of the invention.

What is claimed is:

1. A method of controlling a communications system, comprising:
providing a list of one or more action signal icons, each action signal icon corresponding to an action signal that may be provided;
selecting at least one of the action signal icons to indicate a selected action signal; and
associating the trigger signal with the selected action signal.

2. The method of claim 1, wherein the communications system is an intercom system.

3. The method of claim 1, wherein the communications system includes a user communication device capable of providing a trigger signal.

4. The method of claim 3, wherein the communications system is an intercom station.

5. The method of claim 3, wherein the communications system is a paging system.

6. The method of claim 3, wherein the communications system is telephone system.

7. The method of claim 3, wherein the communications system is a conference system.

8. The method of claim 3, wherein the communications system is a media retrieval system.

9. The method of claim 3, wherein the communications system is a time tracking system.

10. The method of claim 3, wherein the communications system is an event tracking system.

11. The method of claim 1, wherein the list of one or more action signal icons is provided via a monitor.

12. The method of claim 11, wherein the list of one or more action signal icons is provided using a graphical user interface.

13. The method of claim 11, wherein selecting at least one of the action signal icons includes moving an identifying icon displayed on the monitor until the identifying icon coincides with one of the action signal icons.

14. The method of claim 1, wherein associating the trigger signal with the selected action signal includes instructing the controller to provide the selected action signal if the trigger signal is provided.

15. The method of claim 1, wherein one of the action signals is a serial message.

16. The method of claim 1, wherein the trigger signal is a serial message.

17. The method of claim 1, further comprising:
providing the trigger signal; and
providing the selected action signal.

18. The method of claim 17, further comprising:
identifying a device portion associated with the provided trigger signal;
formatting the selected action signal to include the device portion of the provided trigger signal.

19. The method of claim 17, further comprising:
determining whether the provided trigger signal includes a place/end string;
determining whether a line of communication is open;
if it was determined that the provided trigger signal includes a place/end string and a line of communication is open, closing the line of communication.

20. The method of claim 17, further comprising:
determining whether the provided trigger signal includes the place/end string and a device portion;
if it was determined the provided trigger signal includes the place/end string, opening a line of communication to a device corresponding to the device portion.

21. The method of claim 17, wherein the trigger signal is provided by the user communication device.

22. The method of claim 17, wherein the action signal is provided to a programmable logic controller.

23. A method of controlling a communications system, the communications system having a controller capable of providing an action signal, the method comprising:
providing a list of one or more trigger signal icons, each trigger signal icon corresponding to a trigger signal that may be provided;
selecting at least one of the trigger signal icons to indicate a selected trigger signal; and
associating the action signal with the selected trigger signal.

24. The method of claim 23, wherein the communications system is an intercom system.

25. The method of claim 23, wherein the communications system is a paging system.

26. The method of claim 23, wherein the communications system is telephone system.

27. The method of claim 23, wherein the communications system is a conference system.

28. The method of claim 23, wherein the communications system is a media retrieval system.

29. The method of claim 23, wherein the communications system is a time tracking system.

30. The method of claim 23, wherein the communications system is an event tracking system.

31. The method of claim 23, wherein the controller is a computer.

32. The method of claim 23, wherein the list of one or more trigger signal icons is provided via a monitor.

33. The method of claim 32, wherein the list of one or more trigger signal icons is provided using a graphical user interface.

34. The method of claim 32, wherein selecting at least one of the trigger signal icons includes moving an identifying icon displayed on the monitor until the identifying icon coincides with one of the trigger signal icons.

35. The method of claim 23, wherein associating the action signal with the selected trigger signal includes instructing the controller to provide the action signal if the selected trigger signal is provided.

36. The method of claim 23, wherein one of the trigger signals is a serial message.

37. The method of claim 23, wherein the action signal is a serial message.

38. The method of claim 23, further comprising:
providing the selected trigger signal; and
providing the action signal.

39. The method of claim 38, further comprising:
identifying a device portion of the provided trigger signal;
formatting the selected action signal to include the device portion of the provided trigger signal.

40. The method of claim 38, further comprising:
determining whether the provided trigger signal includes a place/end string;
determining whether a line of communication is open;
if it was determined that the provided trigger signal includes the place/end string and a line of communication is open, closing the line of communication.

41. The method of claim 38, further comprising:
determining whether the provided trigger signal includes the place/end string and a device portion;
if it was determined the provided trigger signal includes the place/end string, opening a line of communication to a device corresponding to the device portion.

42. The method of claim 38, wherein the trigger signal is provided by a user communication device.

43. The method of claim 38, wherein the action signal is provided to a programmable logic controller.

44. An article of manufacture comprising a computer usable medium having computer readable program code instructions embodied therein to cause a computer to associate a trigger signal with an action signal, the instructions having:
a computer readable program code module to provide a list of one or more action signal icons, each action signal icon corresponding to an action signal that may be provided;
a computer readable program code module to provide a list of one or more trigger signal icons, each trigger signal icon corresponding to a trigger signal that may be provided;
a computer readable program code module to receive a selection of one of the action signal icons;
a computer readable program code module to receive a selection of one of the trigger signal icons;
a computer readable program code module to associate the action signal corresponding to the selection of one of the action signal icons with a trigger signal corresponding to the selection of one of the action signal icons.

45. The article of manufacture of claim 44, wherein the list of one or more action signal icons includes action signal icons corresponding to action signals for an intercom system.

46. The article of manufacture of claim 44, wherein the list of one or more action signal icons includes action signal icons corresponding to action signals for an paging system.

47. The article of manufacture of claim 44, wherein the list of one or more action signal icons includes action signal icons corresponding to action signals for a telephone system.

48. The article of manufacture of claim 44, wherein the list of one or more action signal icons includes action signal icons corresponding to action signals for a conference system.

49. The article of manufacture of claim 44, wherein the list of one or more action signal icons includes action signal icons corresponding to action signals for a media retrieval system.

50. The article of manufacture of claim 44, wherein the list of one or more action signal icons includes action signal icons corresponding to action signals for a time tracking system.

51. The article of manufacture of claim 44, wherein the list of one or more action signal icons includes action signal icons corresponding to action signals for an event tracking system.

52. The article of manufacture of claim 44, wherein the list of one or more trigger signal icons includes trigger signal icons corresponding to trigger signals for an intercom system.

53. The article of manufacture of claim 44, wherein the list of one or more trigger signal icons includes trigger signal icons corresponding to trigger signals for an paging system.

54. The article of manufacture of claim 44, wherein the list of one or more trigger signal icons includes trigger signal icons corresponding to trigger signals for a telephone system.

55. The article of manufacture of claim 44, wherein the list of one or more trigger signal icons includes trigger signal icons corresponding to trigger signals for a conference system.

56. The article of manufacture of claim 44, wherein the list of one or more trigger signal icons includes trigger signal icons corresponding to trigger signals for a media retrieval system.

57. The article of manufacture of claim 44, wherein the list of one or more trigger signal icons includes trigger signal icons corresponding to trigger signals for a time tracking system.

58. The article of manufacture of claim 44, wherein the list of one or more trigger signal icons includes trigger signal icons corresponding to trigger signals for an event tracking system.

59. The article of manufacture of claim 44, wherein the code module to provide a list of one or more action signal icons is capable of providing the list of one or more action signal icons to a monitor.

60. The article of manufacture of claim 59, wherein the code module to provide a list of one or more action signal icons includes a graphical user interface.

61. The article of manufacture of claim 60, wherein the graphical user interface is capable of allowing an individual to move an identifying icon displayed on a monitor to make the identifying icon coincide with one of the action signal icons.

62. The article of manufacture of claim 44, wherein the code module to provide a list of one or more trigger signal icons is capable of providing the list of one or more trigger signal icons to a monitor.

63. The article of manufacture of claim 44, wherein the code module to provide a list of one or more trigger signal icons includes a graphical user interface.

64. The article of manufacture of claim 63, wherein the graphical user interface is capable of allowing an individual to move an identifying icon displayed on a monitor to make the identifying icon coincide with one of the trigger signal icons.

65. The article of manufacture of claim 44, wherein the code module to associate the action signal with the trigger signal includes instructions capable of causing a signal provider to provide an action signal corresponding to the selection of one of the action signal icons if the associated trigger signal is provided.

66. The article of manufacture of claim 44, further comprising a computer readable program code module to identify a device portion of the associated trigger signal, when the associated trigger signal is provided, and format the associated action signal to include the device portion.

67. The article of manufacture of claim 44, further comprising:
a computer readable program code module to determine whether a received trigger signal includes a place/end string;
a computer readable program code module to determine whether a line of communication is open; and
a computer readable program code module, to close the line of communication, if it was determined a line of communication is open and the received trigger signal includes a place/end string.

68. The article of manufacture of claim 44, further comprising:
a computer readable program code module to determine whether the received trigger signal includes a place/end string and a device portion;
a computer readable program code module to open a line of communication to a device corresponding to the device portion, if the received trigger signal includes the place/end string.

69. A communications system, comprising:
a user communication device capable of providing a trigger signal;
a communicating controller capable of responding to an action signal;
a master controller in communication with the communicating controller and the user communication device, the master controller being controlled by computer executable code for selectively associating the trigger signal with the action signal so that the action signal is provided to the communicating controller if the trigger signal is provided by the user communication device.

70. The system of claim 69, further comprising a monitor in communication with the master controller, the monitor being capable of displaying a trigger signal icon corresponding to the trigger signal, and capable of displaying an action signal icon corresponding to the action signal.

71. The system of claim 69, wherein the computer executable code includes a graphical user interface to facilitate selectively associating the trigger signal with the action signal.

72. The system of claim 69, wherein the master controller is capable of identifying a device portion of a received trigger signal, and capable of formatting an action signal to include the device portion.

73. The system of claim 69, wherein the master controller is capable of (a) determining whether a received trigger signal includes a place/end string, (b) determining whether a line of communication is open, and (c) closing the line of communication if it is determined a line of communication is open and the received trigger signal includes a place/end string.

74. The system of claim 69, wherein the master controller is capable of (a) determining whether the received trigger signal includes a place/end string and a device portion, and (b) opening a line of communication to a device corresponding to the device portion, if the received trigger signal includes the place/end string.
